(19) United States
(12) Patent Application Publication
(10) Pub. No.: US 2013/0129404 A1
(43) Pub. Date: May 23, 2013

(54) Two-way moving structure of a file folder

(71) Applicant: Chun Yuan Chang, Taipei (TW)

(72) Inventor: Chun Yuan Chang, Taipei (TW)

(21) Appl. No.: 13/300,680

(22) Filed: Nov. 21, 2011

(51) Int. Cl. B42F 3/00

(52) U.S. Cl. 402/70

(57) ABSTRACT

A two-way moving structure of a file folder contains a base including two grooves defined on two sides thereof respectively, one stopping portion fixed in each groove, two limiting orifices in the two grooves respectively, and four recesses disposed on four corners thereof individually, each recess of the base includes a hook; two retaining members, and each including two ribs, a resilient extension, a hooking extension, a receiving slot, an anti-slip segment, and a defining element; two moving members, each including a side plate and two connecting posts, the side plate including a slip proof area formed on an outer surface thereof, two axial rotating sections disposed on a bottom end thereof and formed in a semi circle shape, a locking shaft defined between the two axial rotating sections, and a hollow zone fixed on a top end of the locking shaft.

### BACKGROUND OF THE INVENTION

1. Field of the Invention

The present invention relates to a file folder, and more particularly to a two-way moving structure of the file folder.

2. Description of the Prior Art

A conventional file folder is used to store documents. However, when desiring to remove some documents which are fixed on the lowest layer of the file folder, the other documents above the some documents have to be removed first, thus having an inconvenient operation.

The present invention has arisen to mitigate and/or obviate the afore-described disadvantages.

### SUMMARY OF THE INVENTION

The primary object of the present invention is to provide a two-way moving structure of a file folder that is capable of providing operation convenience.

### BRIEF DESCRIPTION OF THE DRAWINGS

FIG. 1 is a perspective view showing the exploded components of a two-way moving structure of a file folder according to a first embodiment of the present invention;

FIG. 2 is a perspective view showing the assembly of the two-way moving structure of the file folder according to the first embodiment of the present invention;

FIG. 3 is a perspective view showing the application of the two-way moving structure of the file folder according to the first embodiment of the present invention;

FIG. 4 is a perspective view showing the operation of a retaining member of the two-way moving structure of the file folder according to the first embodiment of the present invention;

FIG. 5 is another perspective view showing the operation of the retaining member of the two-way moving structure of the file folder according to the first embodiment of the present invention;

FIG. 6 is another perspective view showing the operation of the retaining member of the two-way moving structure of the file folder according to the first embodiment of the present invention;

FIG. 7 is a plan view showing the assembly of the retaining member of the two-way moving structure of the file folder according to the first embodiment of the present invention;

FIG. 8 is a cross sectional view of the assembly of a recess of an axial rotating section according to the first embodiment of the present invention;

FIG. 9 is another cross sectional view of the assembly of the recess of the axial rotating section according to the first embodiment of the present invention;

FIG. 10 is another perspective view showing the application of the two-way moving structure of the file folder according to the first embodiment of the present invention;

FIG. 11 is a side plan view showing the application of the two-way moving structure of the file folder according to the first embodiment of the present invention;

FIG. 12 is a perspective view showing the operation of the two-way moving structure of the file folder according to the first embodiment of the present invention;

FIG. 13 is another perspective view showing the operation of the two-way moving structure of the file folder according to the first embodiment of the present invention;

FIG. 14 is another perspective view showing the operation of the two-way moving structure of the file folder according to the first embodiment of the present invention;

FIG. 15 is a perspective view showing the exploded components of a two-way moving structure of a file folder according to a second embodiment of the present invention;

FIG. 16 is a plan view showing the exploded components of the two-way moving structure of a file folder according to the second embodiment of the present invention.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

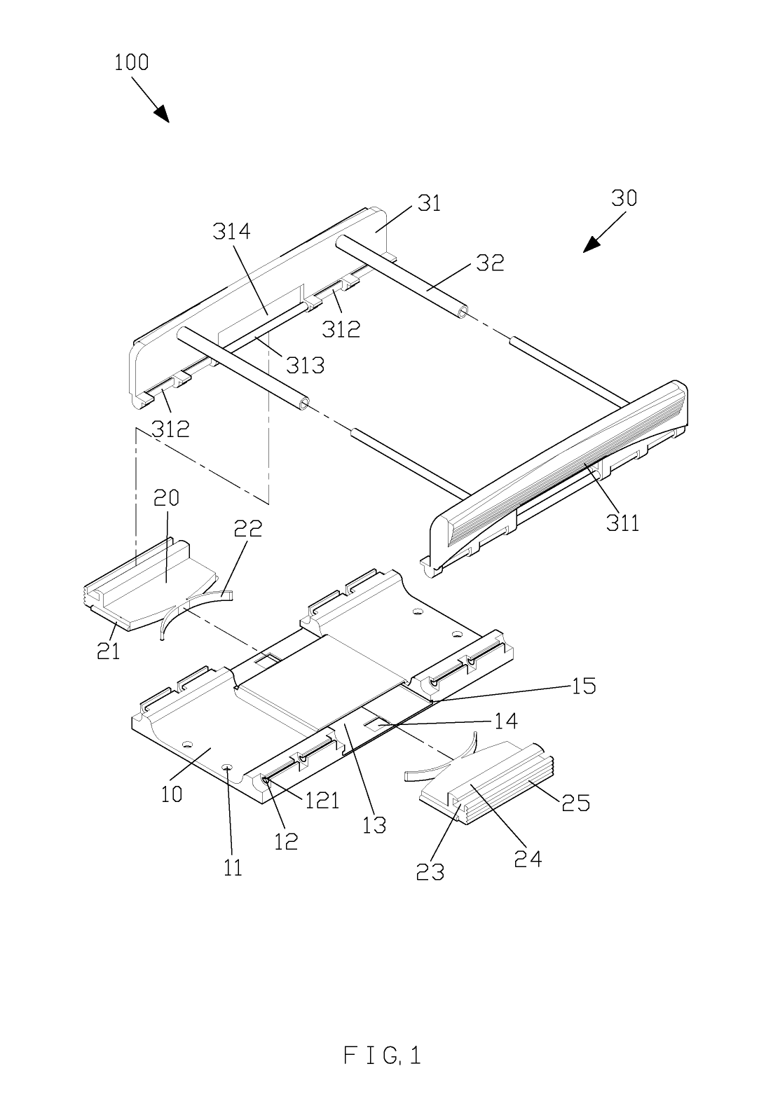

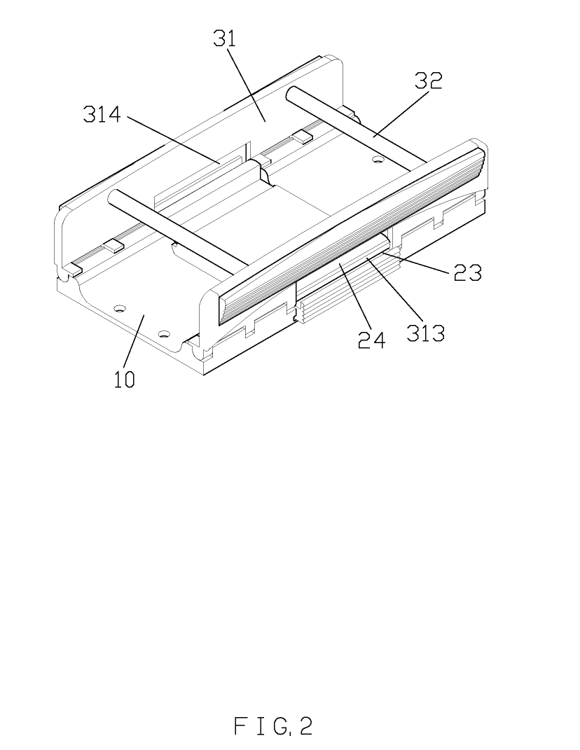

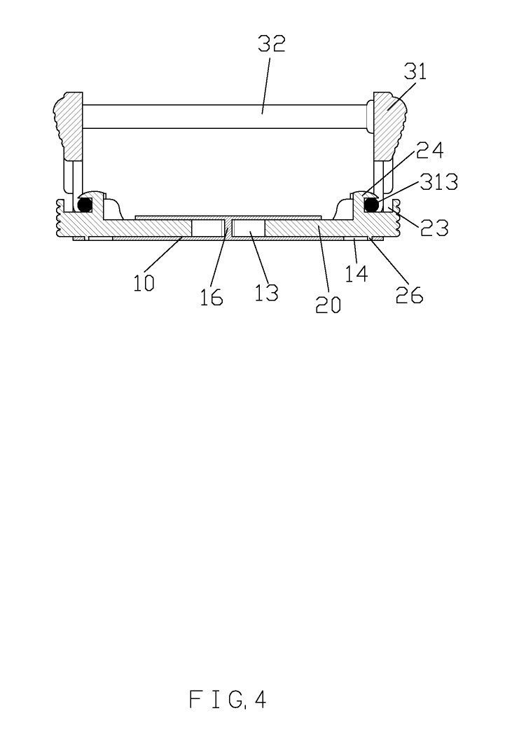

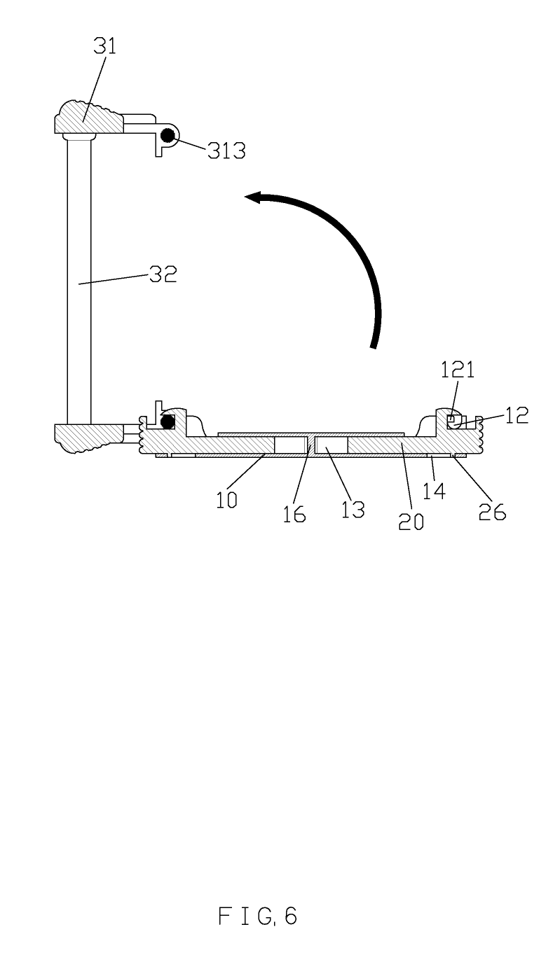

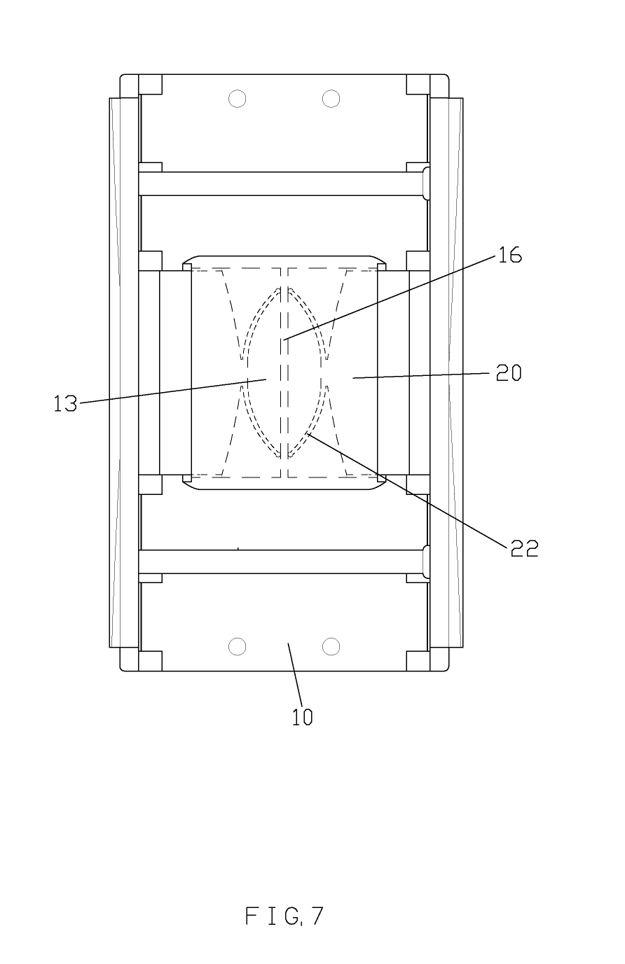

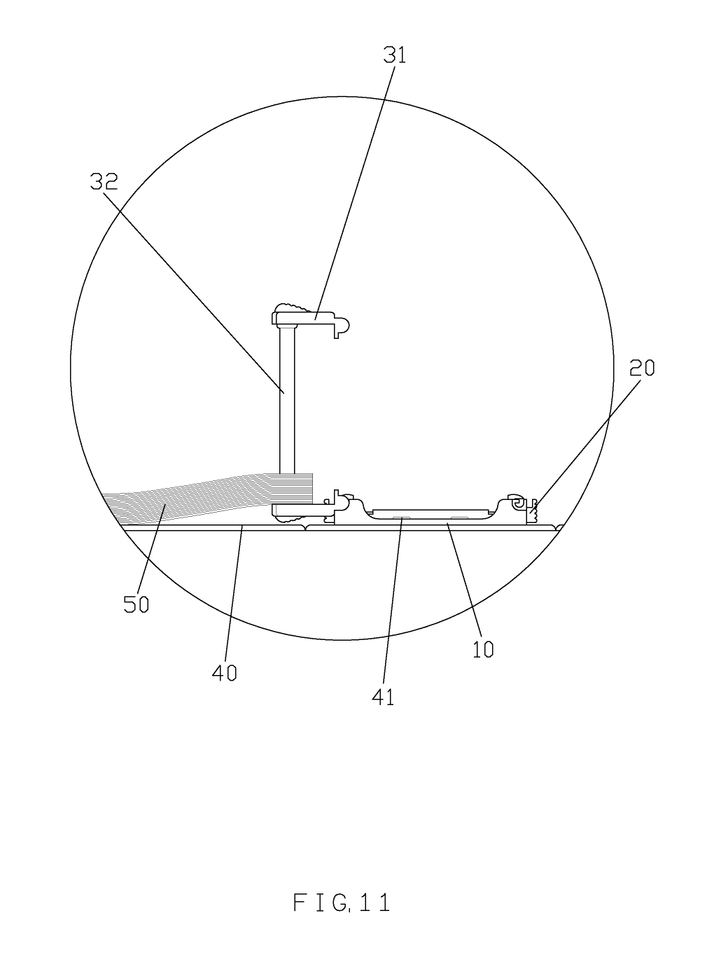

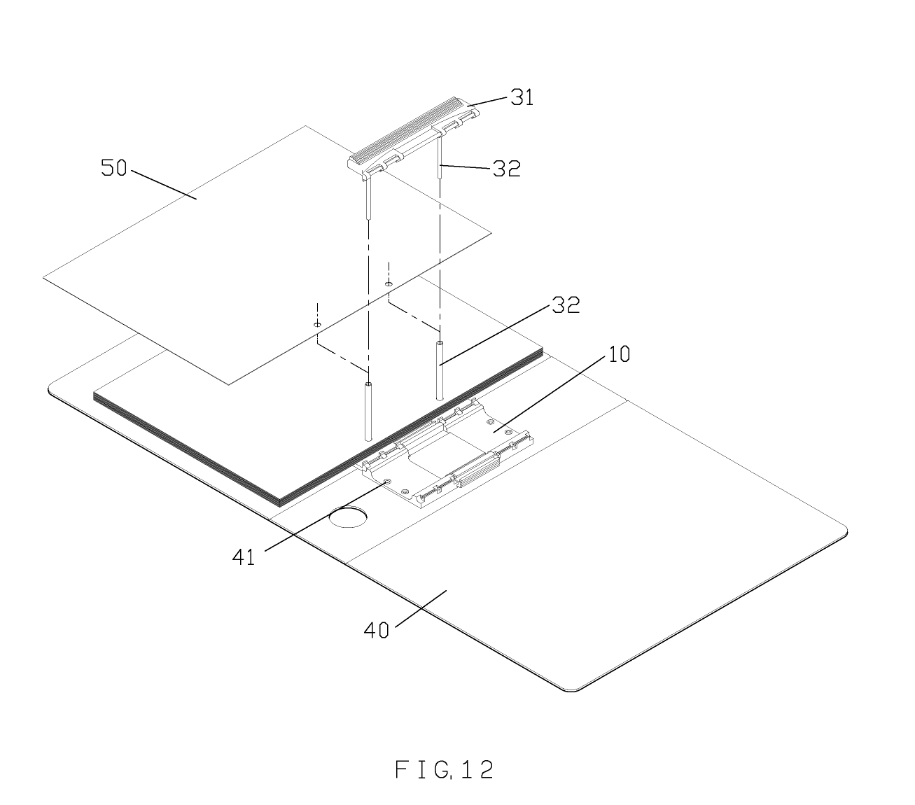

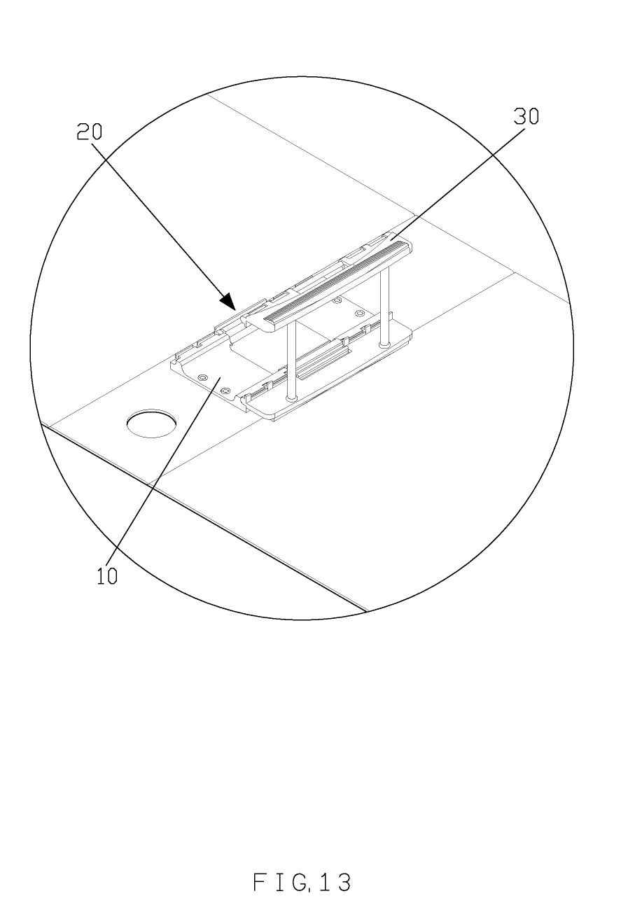

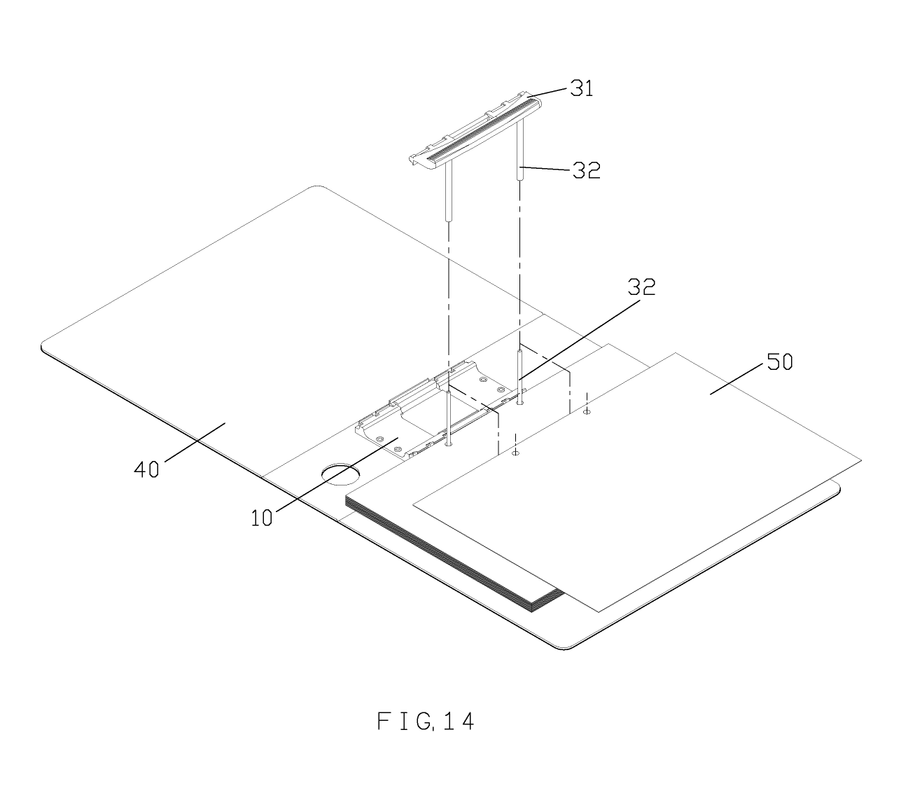

Referring to FIGS. 1-14, a two-way moving structure 100 of a file folder in accordance with a first embodiment of the present invention comprises a base 10, two retaining members 20, and two moving members 30.

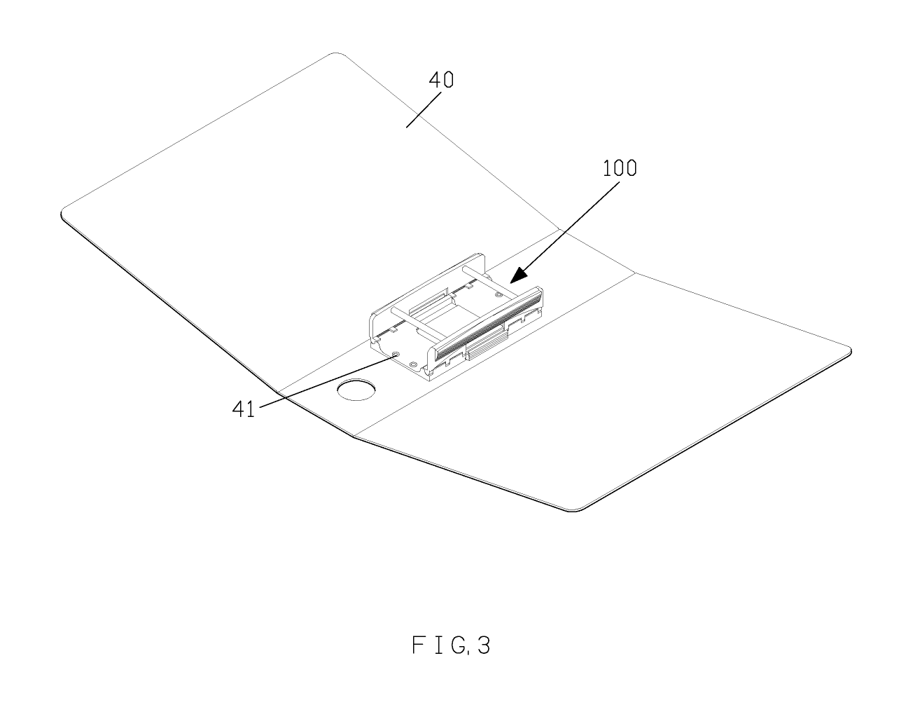

As shown in FIGS. 1-3, the base 10 includes a plurality of through holes 11, and a number of locking elements 41 inserted through the plurality of through holes 11 and positioned on a cover member 40 respectively (as illustrated in FIG. 3), wherein each locking element 41 is a rivet; the base 10 also includes four recesses 12 disposed on four corners thereof individually, two grooves 13 defined each two recesses 12 of two sides thereof respectively, two rails 15 fixed on two sides of the each groove 13 individually, two limiting orifices 14 formed in the two grooves 13 respectively.

With reference to FIGS. 1, 2, and 4, each retaining member 20 includes two ribs 21 secured on two sides thereof individually to correspond to the two rails 15 of the each groove 13, a resilient extension 22 disposed on an inner rim thereof, a hooking extension 24 fixed on an out rim thereof, a receiving slot 23 formed on a lower end of the hooking extension 24, an anti-slip segment 25 arranged on an outer side of the receiving slot 23, and a defining element 26 extending from a lower end thereof to correspond to a respective one of the two limiting orifices 14; such that the two retaining members 20 are fixed in the two grooves 13 of the base 10 individually, and the two ribs 21 of the each retaining member 20 are located in the two rails 15 of the each groove 13, the defining element 26 of the each retaining member 20 is retained in the respective one of the two limiting orifices 14 of the base 10 to prevent the each retaining member 20 from disengagement from the base 10 and to make the anti-slip segment 25 of the each retaining member 20 face outward.

Each moving member 30 includes a side plate 31 and two connecting posts 32 extending outward from an inner rim of the side plate 31 and separating from each other, the side plate 31 includes a slip proof area 311 formed on an outer surface thereof, two axial rotating sections 312 disposed on a bottom end thereof, a locking shaft 313 defined between the two axial rotating sections 312, and a hollow zone 314 fixed on a top end of the locking shaft 313; such that the two axial rotating sections 312 of the each moving member 30 are axially retained in two respective ones of the four recesses 12, and the locking shaft 313 of the each moving member 30 is fixed in the receiving slot 23 of the each retaining member 20, the hooking extension 24 is inserted through the hollow zone 314 to abut against the locking shaft 313, and two respective ones 32 of four connecting posts 32 of the two moving members 30 are fitted with each other.

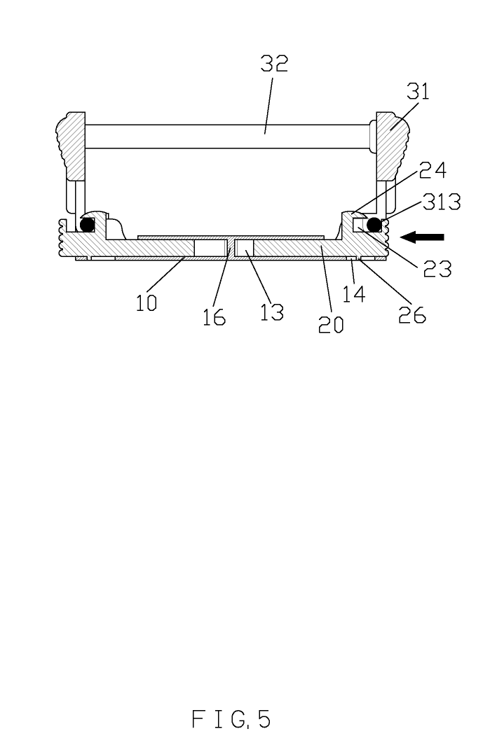

Referring to FIGS. 5-7, in operation, two anti-slip segments 25 of the two retaining members 20 are forced to move the two retaining members 20 inward respectively so that two hooking extensions 24 of the two retaining members 20 disengage from two locking shafts 313 of the two moving members 30 individually, hence the two moving members 30 are rotated along two receiving slots 23 of the two retaining members 20 and the two locking shafts 313 of the two moving members 30 respectively. In addition, two resilient extensions 22 of the two retaining members 20 are biased against two stopping portions 16 of the two grooves 13 of the base 10 individually, obtaining outward automatic pushing purpose.

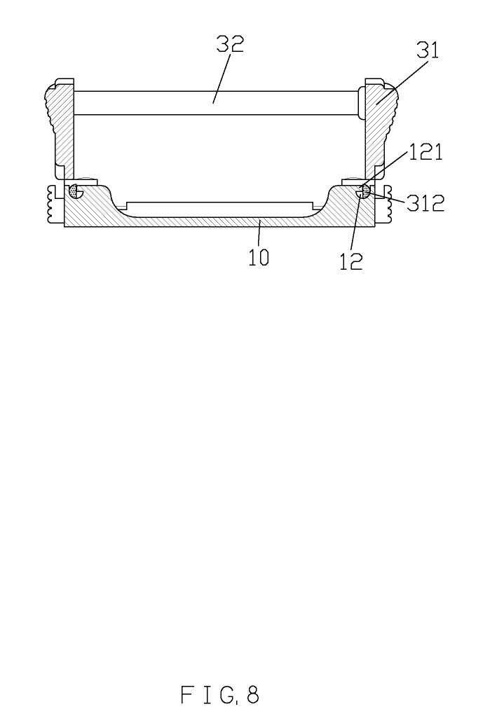

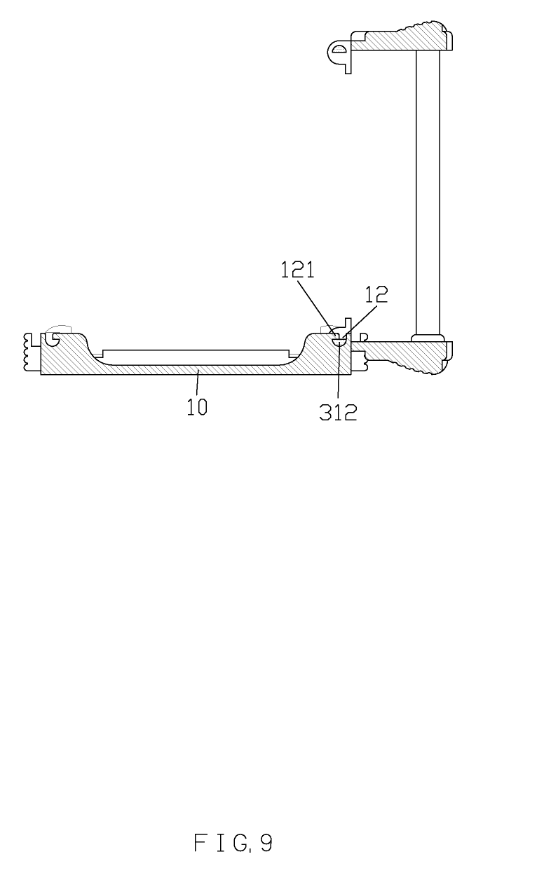

Referring to FIGS. 8 and 9, each recess 12 of the base 10 includes a hook 121 mounted therein to match with a semi-circular respective one of the two axial rotating sections 312 of the each moving member 30 so that when the moving member 30 axially rotates toward any one side, the semi-circular respective one of the two axial rotating sections 312 retains with the hook 121 to enhance a connecting strength of the base 10 and the moving member 30 and to prevent the moving member 30 from disengagement after rotation. When the moving member 30 engages with or disengages from the retaining member 20, the semi-circular respective one of the two axial rotating sections 312 is located outside the hook 121, avoiding crash or interference.

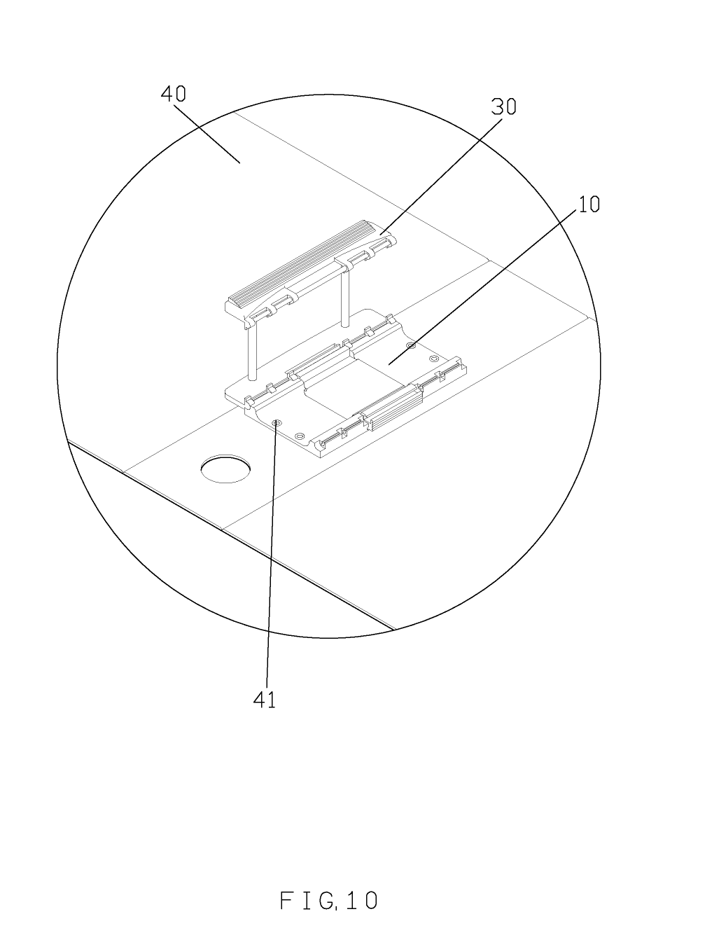

Thereby, when putting a document in the file folder as illustrated in FIGS. 10-14, any one moving member 30 is selected based on requirement to separate the two connecting posts 32 of the moving member 30, which is disengaged, from the two connecting posts 32 of another moving member 30 so that the document 50 is fixed on or is removed from the two connecting posts 32 of the moving member 30.

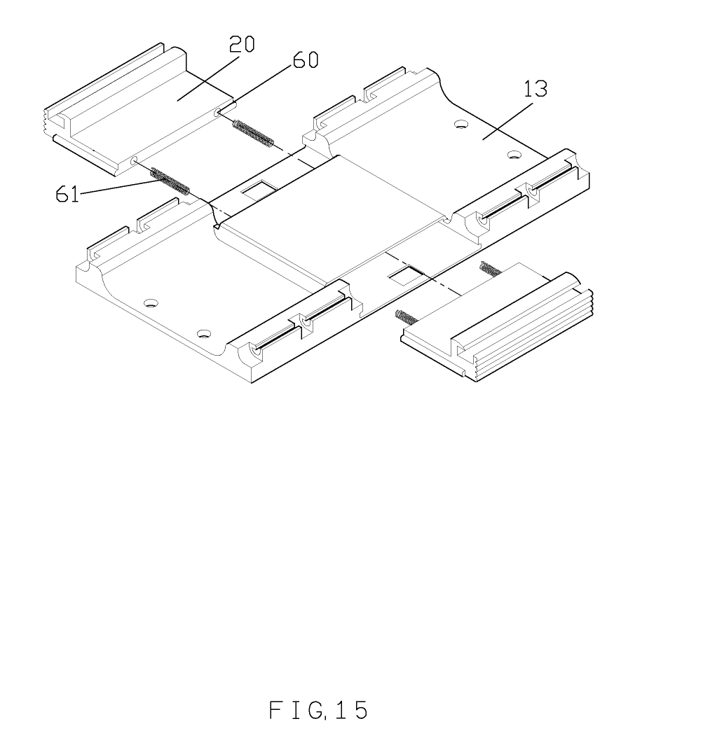

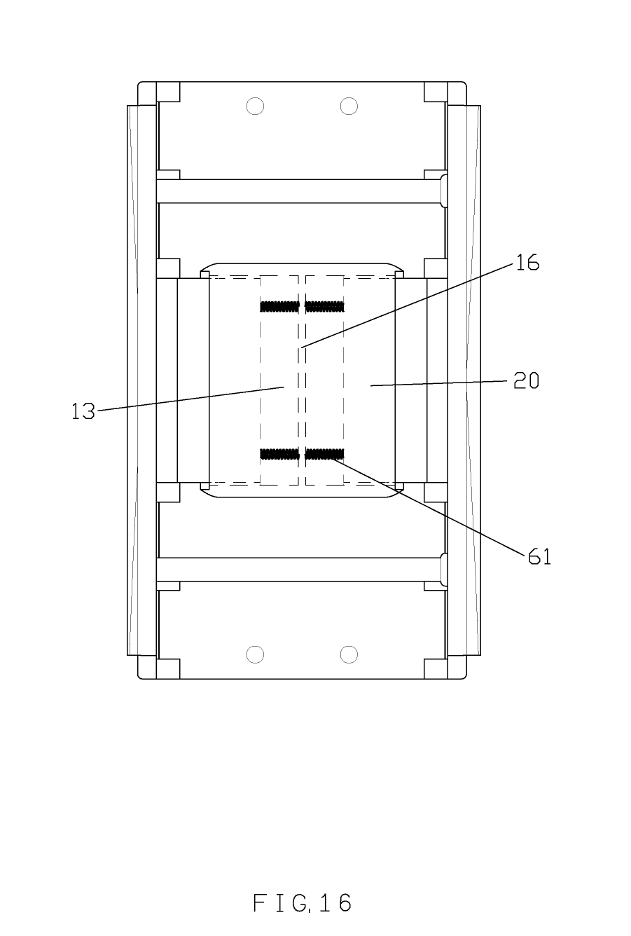

As shown in FIGS. 1, 15, and 16, the resilient extension 22 of the retaining member 20 is capable of being replaced by an elastic element 61 secured in a bore 60 of the retaining member 20 to abut against a respective one of the stopping portions 60 so as to push the retaining member 20 outward.

Although a number of the connecting posts 32 is two, it corresponds to a quantity of holes punched on the document.

While we have shown and described various embodiments in accordance with the present invention, it is clear to those skilled in the art that further embodiments may be made without departing from the scope of the present invention.

What is claimed is:

1. A two-way moving structure of a file folder comprising a base including two grooves defined on two middle sections of two sides thereof respectively, one stopping portion fixed in each groove, two limiting orifices formed in the two grooves respectively, the base also including four recesses disposed on four corners thereof individually, each recess of the base includes a hook mounted therein;
two retaining members fixed in the two grooves respectively, and each retaining member including two ribs secured on two sides thereof individually to correspond to the two grooves, a resilient extension disposed on an inner rim thereof, a hooking extension fixed on an out rim thereof, a receiving slot formed on a lower end of the hooking extension, an anti-slip segment arranged on an outer side of the receiving slot, and a defining element extending from a lower end thereof to correspond to a respective one of the two limiting orifices;
two moving members, each including a side plate and two connecting posts extending outward from an inner rim of the side plate and separating from each other, the side plate including a slip proof area formed on an outer surface thereof, two axial rotating sections disposed on a bottom end thereof and formed in a semi circle shape, a locking shaft defined between the two axial rotating sections, and a hollow zone fixed on a top end of the locking shaft.

2. The two-way moving structure of the file folder as claimed in claim 1, wherein the base includes a plurality of through holes to insert a number of locking elements through the plurality of through holes so that the number of locking elements are positioned on a cover member respectively.

3. The two-way moving structure of the file folder as claimed in claim 1, wherein the two retaining members are retained in the two grooves of the base, the two ribs of the each retaining member are located in the two rails of the each groove, and the defining element of the each retaining member is retained in the respective one of the two limiting orifices of the base.

4. The two-way moving structure of the file folder as claimed in claim 1, wherein the anti-slip segment of the each retaining member faces outward.

5. The two-way moving structure of the file folder as claimed in claim 1, wherein the two resilient extensions of the two retaining members are biased against two stopping portions of the two grooves of the base individually.

6. The two-way moving structure of the file folder as claimed in claim 1, wherein when the moving member axially rotates toward any one side, the semi-circular respective one of the two axial rotating sections retains with the hook.

7. The two-way moving structure of the file folder as claimed in claim 1, wherein when the two moving members and the two retaining members retain together, the semi-circular respective one of the two axial rotating sections is located outside the hook.

8. The two-way moving structure of the file folder as claimed in claim 1, wherein the resilient extension of the retaining member is capable of being replaced by an elastic element secured in a bore of the retaining member.
